(19) United States
(12) Patent Application Publication
(10) Pub. No.: US 2018/0340491 A1
(43) Pub. Date: Nov. 29, 2018

(54) PISTON FOR ENGINE

(71) Applicants: Hyundai Motor Company, Seoul (KR); Kia Motors Corporation, Seoul (KR)

(72) Inventors: Soo Hong Lee, Seoul (KR); Joon Kyu LEE, Yongin-si (KR); Dong Han HUR, Anyang-si (KR); Hyuck Mo KWON, Yongin-si (KR); Sun Young SONG, Anyang-si (KR)

(73) Assignees: Hyundai Motor Company, Seoul (KR); Kia Motors Corporation, Seoul (KR)

(21) Appl. No.: 15/820,242

(22) Filed: Nov. 21, 2017

(30) Foreign Application Priority Data
May 23, 2017 (KR) 10-2017-0063263

(51) Int. Cl. F02F 3/28

(52) U.S. Cl. CPC F02F 3/28

(57) ABSTRACT

A piston of an engine has a bowl including: a top end that is a surface inclined toward a center of the piston from an edge portion of a top of the piston; a central projection protruding upward at a center of the piston; a recession extending outwardly from the central projection and inclined downward beneath the top end; and a neck connecting the recession and the top end to each other wherein a minimum diameter of the neck is within 62˜65% of a cylinder bore diameter, a maximum diameter of the recession is within 102˜105% of the minimum diameter of the neck, a maximum depth from the top of the piston to a deepest portion of the recession is within 10˜20% of the cylinder bore diameter, and a center of a radius of curvature of the neck is disposed within 2˜10% of the cylinder bore diameter.

### CROSS-REFERENCE TO RELATED APPLICATIONS

The present application claims priority to Korean Patent Application No. 10-2017-0063263, filed on May 23, 2017, the entire contents of which is incorporated herein for all purposes by this reference.

### BACKGROUND OF THE INVENTION

### Field of the Invention

The present invention relates to a piston of an engine and, more particularly, to a structure disposed over a piston to form the combustion chamber of an engine.

### Description of Related Art

The combustion chamber for burning fuel in a diesel engine using pistons that reciprocate includes bowls on the tops of the pistons.

The shapes of the piston bowls have a large influence on the combustion characteristic of the fuel, so the shapes of piston bowls that can improve combustibility are required to correspond to exhaust regulations that are continuously enforced.

The information disclosed in this Background of the Invention section is only for enhancement of understanding of the general background of the invention and should not be taken as an acknowledgment or any form of suggestion that this information forms the prior art already known to a person skilled in the art.

### BRIEF SUMMARY

Various aspects of the present invention are directed to providing a piston of an engine that has a shape configured to improve fuel efficiency and reduce noxious substances by optimizing a fuel injection region and improving the flow of a gas mixture.

To achieve the above object, according to an exemplary embodiment of the present invention, there is provided a piston of an engine, the piston having a bowl that has: a top end that is an inclined surface, inclined toward a center of the piston from an edge portion of a top of the piston; a central projection protruding upward at the center portion of the piston; a recession extending outwardly from the central projection and inclined downward under the top end; and a neck smoothly connecting the recession and the top end to each other, in which a minimum diameter of the neck is within the range of 62˜65% of a cylinder bore diameter configured for inserting the piston, a maximum diameter of the recession is within the range of 102˜105% of the minimum diameter of the neck, a maximum depth that is a distance from the top of the piston to the deepest portion of the recession is within a range of 10˜20% of the cylinder bore diameter, and a center of the radius of curvature of the neck in a vertical cross-section of the piston is disposed within the range of 2˜10% of the cylinder bore diameter.

The angle between the top end and the top of the piston may be within the range of 20 to 40 degrees.

The radius of curvature of the neck may be within the range of 2˜4% of the cylinder bore diameter.

In the vertical cross-section of the piston, the center potion of the central projection may have a predetermined radius of curvature and may be connected to the recession by a common tangential line.

The central depth from the top of the piston to the uppermost end portion of the central projection may be 4% or more as well as less than 10% of the cylinder bore diameter.

The radius of curvature of the central projection may be within the range of 27˜35% of the cylinder bore diameter in the vertical cross-section of the piston.

The center of the radius of curvature of the central projection may be positioned at 31% or more of the cylinder bore diameter under the top of the piston.

The radius of curvature of the recession may be within the range of 5.5˜6.5% of the cylinder bore diameter in the vertical cross-section of the piston.

Various aspects of the present invention are directed to providing a piston having a combustion chamber shape that provides an optimized fuel spray region and improves flow of a gas mixture, improving fuel efficiency of an engine and reducing noxious substances generated from the engine.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a vertical cross-sectional view of a piston of an engine according to an exemplary embodiment of the present invention;

FIG. 2 is a view comparing a structural change in the piston of an engine according to an exemplary embodiment of the present invention with the structure of a piston of the related art;

FIG. 3 is a graph comparing brake specific fuel consumptions according to the percentage of the minimum neck diameter D1 to a cylinder bore diameter Db;

FIG. 4 is a graph comparing soot emissions from an engine according to the percentage of the minimum neck diameter D1 to a cylinder bore diameter Db;

FIG. 5 is a graph comparing brake specific fuel consumptions according to the angle A1 between a top end and a top of a piston;

FIG. 6 is a graph comparing brake specific fuel consumptions according to the percentage of the radius of curvature R1 of a central projection to a cylinder bore diameter Db; and

FIG. 7 is a graph comparing soot emissions from an engine according to the percentage of the radius of curvature R2 of a recession to a cylinder bore diameter Db.′

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

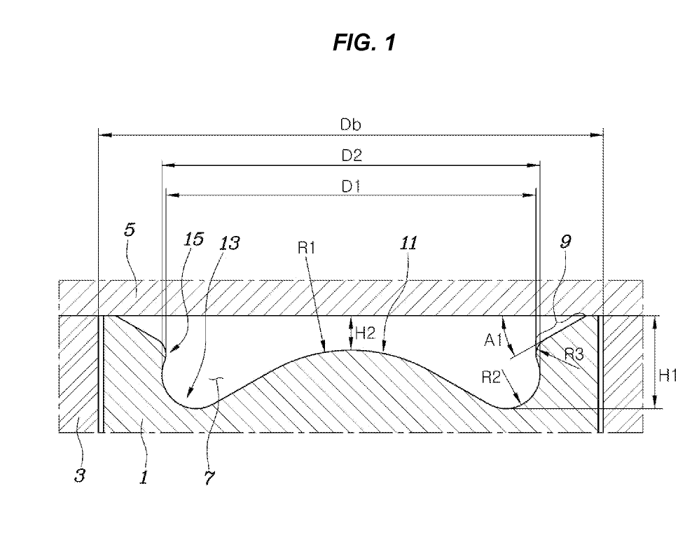

Referring to FIG. 1, a piston 1 is inserted to vertically reciprocate in a cylinder bore 3, and a piston head 5 is disposed on top of the piston 1 to form a combustion chamber with a bowl 7 of the piston 1, described below.

The piston 1 of an engine of the present invention has a bowl 7 that has: a top end 9 that is an inclined surface inclined toward the center of the piston 1 from the edge portion of the top of the piston 1; a central projection 11 protruding upward at the center of the piston 1; a recession 13 extending outwardly from the central projection 11 and inclined downward under the top end 9; and a neck 15 smoothly connecting the recession 13 and the top end 9 to each other.

A minimum diameter D1 of the neck 15 is within the range of 62˜65% of a cylinder bore diameter Db configured for inserting the piston 1, a maximum diameter D2 of the recession 13 is within the range of 102˜105% of the minimum diameter D1 of the neck 15, a maximum depth H1 that is the distance from the top of the piston 1 to the deepest portion of the recession 13 is within the range of 10˜20% of the cylinder bore diameter Db, and the center of the radius of curvature R3 of the neck 15 in the vertical cross-section of the piston 1 is disposed within the range of 2˜10% of the cylinder bore diameter Db.

In detail, when the diameter Db of the cylinder bore is 77 mm, the minimum diameter D1 of the neck 15 may be 49.1 mm which is 63.7% of the cylinder bore diameter Db, the maximum diameter D2 of the recession 13 may be 50.4 mm which is 102.6% of the minimum diameter D1 of the neck 15, the maximum depth H1 may be 13 mm which is 16.8% of the cylinder bore diameter Db, and the center of the radius of curvature R3 of the neck 15 may be positioned at 7 mm which is 9% of the cylinder bore diameter Db under the top of the piston 1.

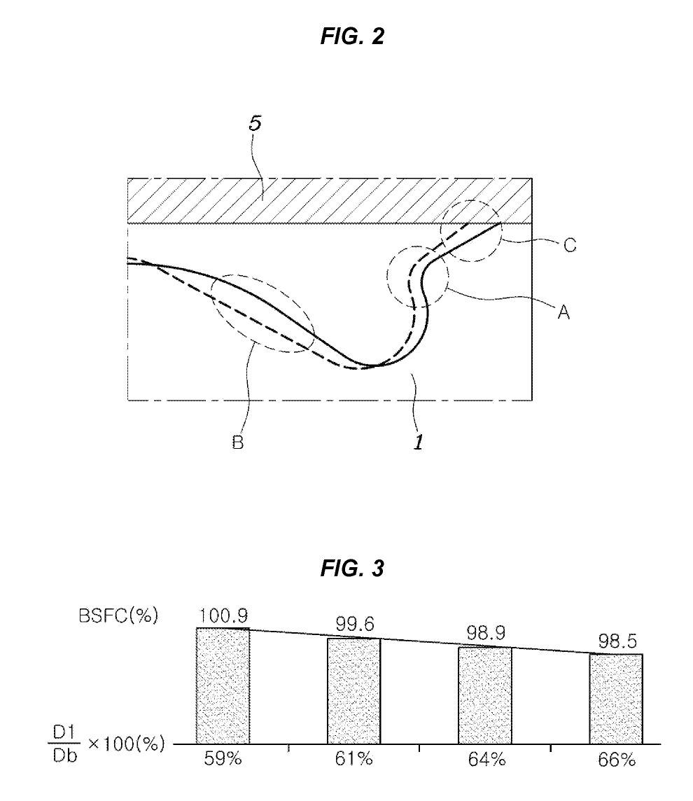

The present detailed configuration substantially changes the shape of a combustion chamber, as compared with the related art. In FIG. 2, a combustion chamber shape formed by a bowl 7 of a piston 1 of the related art and a combustion chamber shape formed by the bowl 7 of the piston 1 according to an exemplary embodiment of the present invention are compared for only the right portion of the vertical cross-section of the pistons 1, and the dotted line shows the related art and the solid line shows the present invention.

The limits on the minimum diameter D1 of the neck 15 and the maximum diameter D2 of the recession 13 make the neck 15 extend radially outward in the bowl 7, that is, widen the center portion of the combustion chamber, as shown in portion A of FIG. 2. Accordingly, when fuel is sprayed from an injector at the center potion of the combustion chamber under the same fuel spray condition, the possibility of fuel particles directly coming in contact with the wall of the combustion chamber is reduced, improving the fuel efficiency of a vehicle.

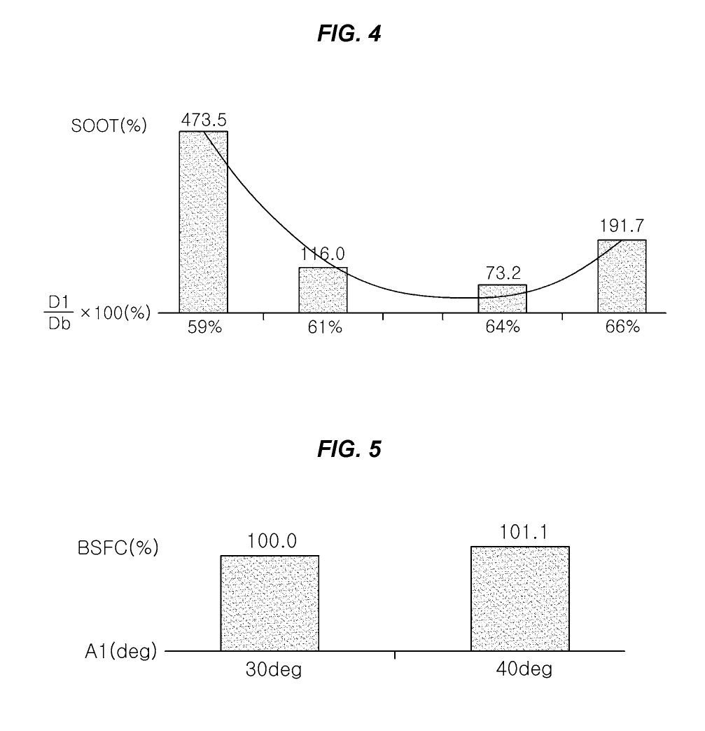

When the minimum diameter D1 of the neck 15 and the maximum diameter D2 of the recession 13 are continuously increased, as shown in FIG. 3, Brake Specific Fuel Consumption (BSFC) decreases and the fuel efficiency continuously increases, but the amount of soot generated in an exhaust gas from an engine decreases and then increases, as shown in FIG. 4.

Accordingly, the minimum diameter D1 of the neck 15 to the cylinder bore diameter Db at which the fuel efficiency can be improved within a range where soot can be minimized may be determined within 62˜65% of the cylinder bore diameter Db for inserting the piston 1.

The angle A1 between the top end 9 and the top of the piston 1 may be within 20 to 40 degrees, and the radius of curvature R3 of the neck 15 may be within 2˜4% of the cylinder bore diameter Db. In detail, when the cylinder bore diameter Db is 77 mm, the radius of curvature R3 of the neck 15 may be set at 2.3 mm which is 2.9% of the cylinder bore diameter Db.

As described above, the limits on the angle A1 between the top end 9 and the top of the piston 1 and the radius of curvature R3 of the neck 15 increase the diameter of the bowl 7, as compared with the related art, as shown in the portion C of FIG. 2, widening the center portion of the combustion chamber. Accordingly, a structure advantageous for improving fuel efficiency is achieved.

When it is required to satisfy a compression ratio for an engine with the maximum depth H1 of the recession 13, a central depth H2, described below, the radius of curvature R1 of the central projection 11 fixed at the provided values, and when the angle between the top end 9 and the top of the piston 1 is less than 20 degrees, it is difficult to increase the minimum diameter D1 of the neck 15 up to the value described above, so the center portion of the combustion chamber cannot be widened wherein fuel efficiency is improved and soot generation is minimized.

Furthermore, when the angle A1 between the top end 9 and the top of the piston 1 is greater than 40 degrees, it can be seen that, as shown in FIG. 5, the BSFC is increased and the fuel efficiency starts to decrease, as compared with an A1 value of 30 degrees.

Meanwhile, in the vertical cross-section of the piston 1, the center potion of the central projection 11 has a predetermined radius of curvature R1 and is connected to the recession 13 through a common tangential line.

That is, the portion having the radius of curvature R1 of the central projection 11 and the portion having the radius of curvature R2 of the recession are connected by one common tangential line, so they are smoothly connected.

The central depth H2 from the top of the piston 1 to the uppermost end portion of the central projection 11 is 4% or more as well as less than 10% of the cylinder bore diameter Db. The radius of curvature R1 of the central projection 11 is within the range of 27˜35% of the cylinder bore diameter Db in the vertical cross-section of the piston 1. The center of the radius of curvature R1 of the central projection 11 is positioned at 31% or more of the cylinder bore diameter Db under the top of the piston 1. The radius of curvature R2 of the recession 13 may be within the range of 5.5˜6.5% of the cylinder bore diameter Db in the vertical cross-section of the piston 1.

In detail, for example, when the cylinder bore diameter Db is 77 mm, the central depth H2 may be 3.6 mm which is 4.6% of the cylinder bore diameter Db, and in the vertical cross-section of the piston 1 the radius of curvature R1 of the central projection 11 may be 21 mm which is 27% of the cylinder bore diameter Db, the center of the radius of curvature R1 of the central projection 11 may be positioned at 24.6 mm which is 32% of the cylinder bore diameter Db under the top of the piston 1, and the radius of curvature R2 of the recession 13 may be 4.5 mm which is 5.8% of the cylinder bore diameter Db.

As described above, since the radius of curvature R1 of the central projection 11 is increased, as compared with the related art, the portion connected to the portion having the radius of curvature R1 of the central projection 11 by a common tangential line is moved outwardly relative to the center of the bowl 7. Accordingly, the region indicated by ‘B’ in FIG. 2 has a smooth upwardly convex shape, as compared to a simple straight inclined surface in the related art, so flow of a fuel-air mixture is enhanced in the combustion chamber and fuel efficiency is improved, as compared with the related art.

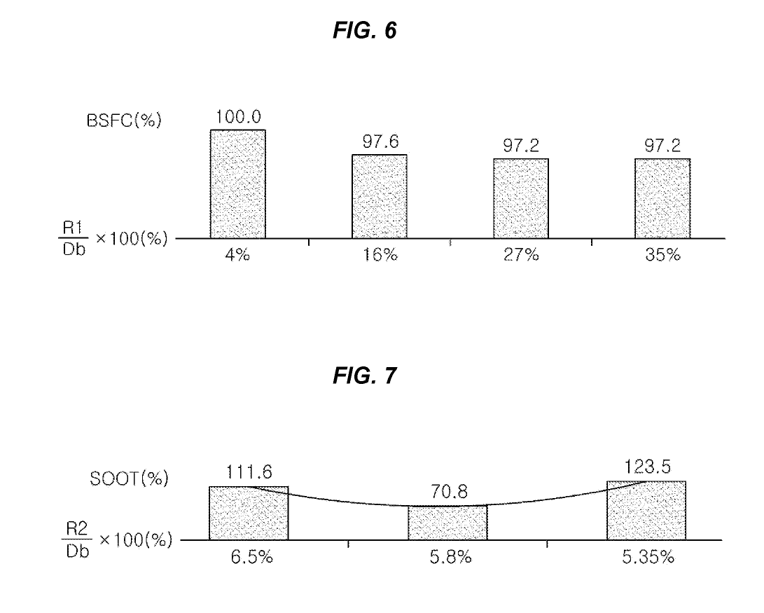

Referring to FIG. 6 showing BSFC according to a change in percentage of the radius of curvature R1 of the central projection 11 to the cylinder bore diameter Db, it can be seen that when the percentage of the radius of curvature R1 of the central projection 11 to the cylinder bore diameter Db is within the range of 27˜35%, the BSFC is the minimum. Accordingly, a combustion chamber shape that can improve fuel efficiency can be provided by limiting the percentage of the radius of curvature R1 of the central projection 11 to the cylinder bore diameter Db in the present way.

Furthermore, referring to FIG. 7 showing a change in percentage of the radius of curvature R of the recession 13 to the cylinder bore diameter Db in the vertical cross-section of the piston 1 and the emission of soot from an engine according to the change, it can be seen that the emission of soot is minimum when the percentage of the radius of curvature R of the recession 13 to the cylinder bore diameter Db is approximately 5.8%.

Accordingly, it is possible to ensure an engine combustion chamber that can reduce the emission of soot by proposing the radius of curvature R2 of the recession 12 at the level described above.

For reference, FIG. 3, FIG. 4, FIG. 5, FIG. 6, and FIG. 7 are graphs depicting relative comparisons in percentage under conditions using the average of operation results at five partial load operation points of an engine.

For convenience in explanation and accurate definition in the appended claims, the terms “upper”, “lower”, “up”, “down”, “upwards”, “downwards”, “internal”, “outer”, “inside”, “outside”, “inwardly”, “outwardly”, “internal”, “external”, “front”, “rear”, “back”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A piston of an engine, the piston having a bowl including:
a top end that is a surface inclined toward a center of the piston from an edge portion of a top of the piston;
a central projection protruding upward at the center of the piston;
a recession extending outwardly from the central projection and inclined downward under the top end; and
a neck connecting the recession and the top end to each other,
wherein a minimum diameter of the neck is within a range of 62˜65% of a cylinder bore diameter configured for inserting the piston,
a maximum diameter of the recession is within a range of 102˜105% of the minimum diameter of the neck,
a maximum depth that is a distance from the top of the piston to a deepest portion of the recession is within a range of 10˜20% of the cylinder bore diameter, and
a center of a radius of curvature of the neck in a vertical cross-section of the piston is disposed within a range of 2˜10% of the cylinder bore diameter.

2. The piston of claim 1, wherein an angle between the top end and the top of the piston is within a range of 20 to 40 degrees, and
the radius of curvature of the neck is within a range of 2˜4% of the cylinder bore diameter.

3. The piston of claim 2, wherein, in the vertical cross-section of the piston, a center potion of the central projection has a predetermined radius of curvature and is connected to the recession by a common tangential line.

4. The piston of claim 3, wherein a central depth from the top of the piston to an uppermost end portion of the central projection is 4% or more as well as less than 10% of the cylinder bore diameter,
the radius of curvature of the central projection is within a range of 27˜35% of the cylinder bore diameter in the vertical cross-section of the piston,
a center of the radius of curvature of the central projection is disposed at 31% or more of the cylinder bore diameter under the top of the piston, and
the radius of curvature of the recession is within a range of 5.5˜6.5% of the cylinder bore diameter in the vertical cross-section of the piston.
